(19) United States
(12) Patent Application Publication
(10) Pub. No.: US 2016/0294026 A1
(43) Pub. Date: Oct. 6, 2016

(54) BATTERY COOLING STRUCTURE

(71) Applicant: TOYOTA JIDOSHA KABUSHIKI KAISHA, Toyota-shi, Aichi-ken (JP)

(72) Inventors: Takenori TSUCHIYA, Toyota-shi, Aichi-ken (JP); Shogo YONEDA, Okazaki-shi, Aichi-ken (JP); Ryuichi OOMUTA, Okazaki-shi, Aichi-ken (JP); Tetsuo WATANABE, Okazaki-shi, Aichi-ken (JP); Yosuke MARUTA, Toyota-shi, Aichi-ken (JP)

(73) Assignee: TOYOTA JIDOSHA KABUSHIKI KAISHA, Toyota-shi, Aichi-ken (JP)

(21) Appl. No.: 15/031,127

(22) PCT Filed: Oct. 21, 2014
(86) PCT No.: PCT/IB2014/002178

§ 371 Date: Apr. 21, 2016

(30) Foreign Application Priority Data
Oct. 31, 2013 (JP) 2013-227120

(51) Int. Cl. H01M 10/6563; B60K 11/08; B60L 11/18; B60K 11/06; H01M 10/613; H01M 10/625

(52) U.S. Cl. CPC H01M 10/6563; H01M 10/613; H01M 10/625; B60L 11/1874; B60K 11/06; B60K 11/08; H01M 2220/20

(57) ABSTRACT

The invention relates to a battery cooling structure for cooling a battery mounted in a vehicle. This battery cooling structure includes a battery pack, a blower, and an intake air duct. The battery pack houses the battery in an internal space. The blower is configured to deliver cooling air into the battery pack. The intake air duct is connected to an intake side of the blower. Also, an inlet (62) of the intake air duct (60) is provided only on a side surface on a door side of a lower trim (12) positioned on an outer edge of a space below a seat cushion (10a).

### BACKGROUND OF THE INVENTION

1. Field of the Invention

The invention relates to a battery cooling structure for cooling a battery mounted in a vehicle.

2. Description of Related Art

Vehicles such as hybrid vehicles (HV) and electric vehicles (EV) run by driving a motor using electric power from a battery. Therefore, a battery that ensures the necessary electric power is mounted in the vehicle.

This battery generates heat, as it charges and discharges. In particular, with a battery for a vehicle, large current often flows, so the amount of heat generated is large. If the temperature of the battery becomes high, the battery will deteriorate, so it is necessary to provide ,a structure to cool the battery. JP 2011-031778 A proposes a structure that draws air into a vehicle cabin from below a rear seat, and uses the drawn in air to cool the battery.

JP 2011-031778 A describes the, battery as being arranged below the rear seat.

Here, in JP 2011-031778 A, the battery and the like are arranged on a back side of a seatback of the rear seat. Also, the intake for the cooling air is provided in a front surface and a side surface of a lower portion of the rear seat. The front surface of the lower portion of the rear seat is easily accessible by an occupant seated in the rear seat, and is easily blocked when an object is placed on the floor.

### SUMMARY OF THE INVENTION

In view of the problems described above, one aspect of the invention relates to a battery cooling structure for cooling a battery mounted in a vehicle. This battery cooling structure includes a battery pack, a blower, and an intake air duct. The battery pack houses the battery in an internal space of the battery pack. The blower is configured to deliver cooling air into the battery pack. The intake air duct is connected to an intake side of the blower. Also, the intake air duct has an inlet that is provided only on a side surface on a door side of a lower trim, the lower trim being positioned on an outer edge of a space below a seat cushion of the vehicle.

Also, in the battery cooling structure described above, an intake side of the battery pack and the intake air duct may be arranged in the space below the seat cushion of the vehicle.

Another aspect of the invention relates to a battery cooling structure for cooling a battery mounted in a vehicle. This battery cooling structure includes a battery pack, a blower, and an intake air duct. The battery pack houses the battery in an internal space of the battery pack. The blower is configured to deliver cooling air into the battery pack. The intake air duct is connected to an intake side, of the blower. An intake side of the battery pack and the intake air duct is arranged in a space below a seat cushion of the vehicle. An inlet of the intake air duct is provided in a side surface on a door side of a lower trim, the lower trim being positioned on an outer edge of the space below the seat cushion.

Also, in the battery cooling structure described above, the inlet of the intake air duct may be slanted with respect to a vehicle front-rear direction so as to come closer to the door side farther toward a rear of the vehicle.

Also, in the battery cooling structure described above, the inlet of the intake air duct may be arranged in a position farther away from the door than the door-side outer edge of the seat cushion. Also, the inlet of the intake air duct may be arranged in a position recessed from a surface of the lower trim, with respect to the door-side outer edge of the seat cushion.

Also, in the battery cooling structure described above, the inlet of the intake air duct may be arranged in a position farther away from the door than the door-side outer edge of the seat cushion. Also, the inlet of the intake air duct may be arranged in a position recessed from the surface of the lower trim with respect to the door-side outer edge of the seat cushion.

According to the battery cooling structure of the invention described above, the inlet is not easily accessible to an occupant, and foreign objects are able to be inhibited from getting into the inlet and the like.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIGS. 1A and 1B are views illustrating the flow of supply air and exhaust air to and from a battery pack according to a battery cooling structure of one example embodiment of the invention;

FIG. 2 is a view of the exterior of the battery pack and a duct according to the battery cooling structure of the example embodiment;

FIGS. 3A, 3B, and 3C are views of the exterior of the exhaust air duct, a supply air duct, a blower, and an intake air duct according to the battery cooling structure of the example embodiment;

FIG. 4 is a cross-sectional plan view of the intake air duct according to the battery cooling structure of the example embodiment;

FIG. 5 is a longitudinal sectional view of the intake air duct on a side of a rear seat according to the battery cooling structure of the example embodiment; and

FIG. 6 is a longitudinal sectional view of the intake air duct behind the rear seat according to the battery cooling structure of the example embodiment.

### DETAILED DESCRIPTION OF EMBODIMENTS

Hereinafter, example embodiments of the invention will be described with reference to the accompanying drawings. The invention is not limited to the example embodiments described here.

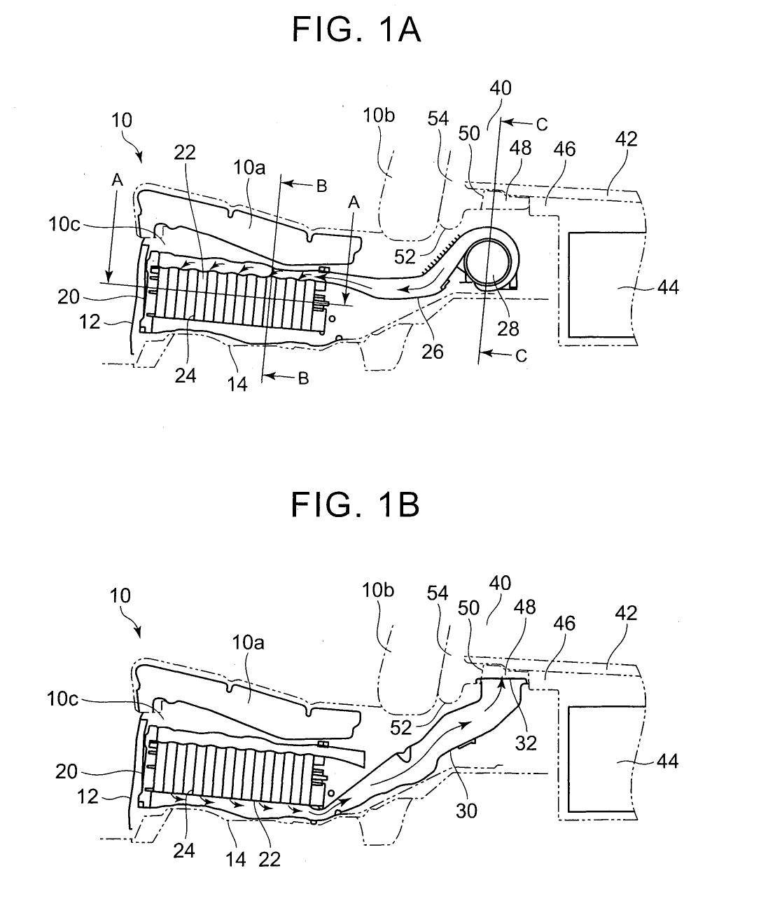

First, the structure related to supply air and exhaust air in a battery cooling structure of this example embodiment will be described. FIGS. 1A and 1B are views of the structure related to the flow of supply air and exhaust air to and from a battery pack in this example embodiment.

A rear seat 10 includes a seat cushion 10a, a seatback 10b, and a battery housing space 10c below the seat cushion 10a. The front and sides of the battery housing space 10c are surrounded by a lower trim 12. Also, a vehicle body 14 is positioned on a bottom surface side of the battery housing space 10c.

A battery pack 20 is arranged inside of the battery housing space 10c, and a battery stack 22 is arranged inside of this battery pack 20. This battery stack 22 is formed by a plurality of battery modules 24 connected together in series.

The inside of the battery pack 20 is sealed by a lower case and an upper cover. A supply air flow path is formed above the battery stack 22 and an exhaust air flow path is formed below the battery stack 22.

A supply air duct 26 is connected to a rear side of the supply air flow path above the battery stack 22 inside the battery pack 20, as shown in FIG. 1A, and this supply air duct 26 extends toward the rear and is connected to a blowing side of a blower 28.

An intake air duct is connected to an intake side of the blower 28. This intake air duct is configured to draw in air from an inlet on a side surface on a door side of the lower trim 12 of the rear seat 10.

An exhaust air duct 30 is connected to a rear side of the exhaust air flow path below the battery stack 22 of the battery pack 20, as shown in FIG. 1B, and this exhaust air duct 30 extends toward the rear, with an exhaust port 32 opening upward.

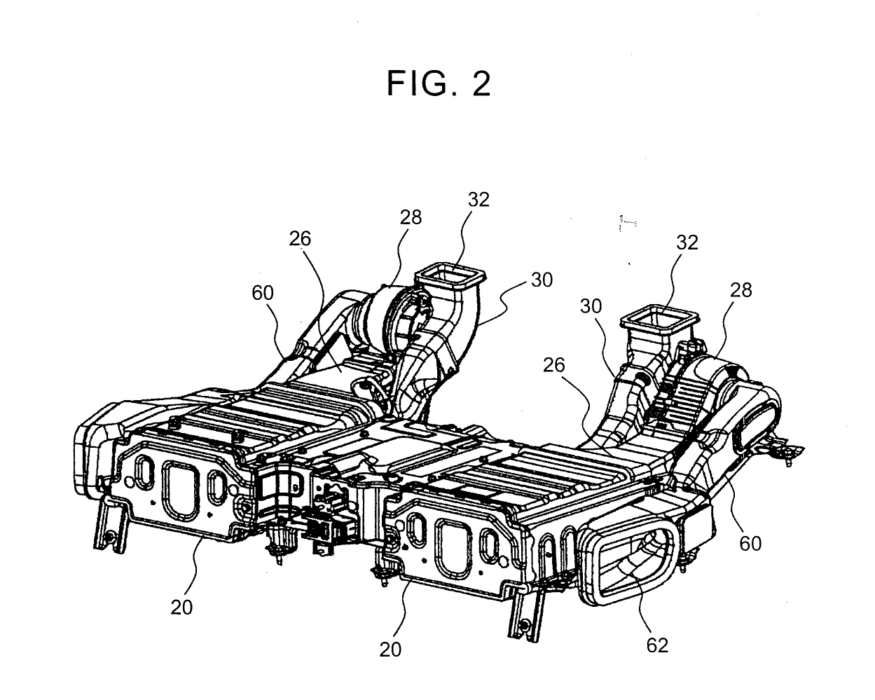

The intake air duct 60 (see FIG. 2), the supply air duct 26, and the exhaust air duct 30 are arranged in order from the door side toward the inside, in the space below the seat cushion 10a of the rear seat 10.

A rear side (back) space of the seatback 10b of the rear seat 10 serves as a luggage space 40. A floor surface of the luggage space 40 is formed by a deck board 42. This deck board 42 is placed, and is thus able to be picked up and removed. A spare tire space 44 within which a spare tire is housed is provide below the deck board 42, and a spare tire is housed here. Also, an accessories compartment 46 such as a shelf is provided below the deck board 42, at a front upper portion in the spare tire space 44.

Also, the blower 28 described above is arranged behind the rear seat 10 and in front of the spare tire space 44. That is, there is a space below the luggage space 40 to the rear of the rear seat 10 and in front of the spare tire space 44, and the blower 28 is arranged here. The intake air duct 60 (see FIG. 2) and the supply air duct 26 are connected to this blower 28. Also, a rear side portion of the exhaust air duct 30 and the exhaust port 32 are provided. A discharge duct 48 that extends in a vehicle width direction is provided on an upper portion of this exhaust port 32, and a discharge port panel 50 is provided on a front surface of this discharge duct 48. This discharge port panel 50 has a closed portion and an open portion. The open portion is an exhaust port. An exhaust vent 54 formed by a gap between a tip end of the deck board 42 and a back surface of the seatback 10b above this exhaust port is open to the luggage space 40. A seat member 52 is provided between a lower front end of the discharge duct 48 and the back surface of the seatback 10b so that objects will not fall down.

Here, FIG. 2 is a perspective view of the battery pack 20 and a duct. In this way, the intake air duct 60 is connected to the intake side of the blower 28. This intake air duct 60 draws in air from an inlet 62 in a side surface on the door side of lower trim of the rear seat 10. In FIG. 2, the seat cushion 10a and the lower trim 12 and the like shown in FIGS. 1A and 1B have been removed, but the inlet 62 is open to the door-side side surface of the lower trim 12. Cloth or lattice or the like is placed over the front surface of the inlet 62 to inhibit foreign objects from getting in from the outside.

In this way, the intake air duct 60, the supply air duct 26, and the exhaust air duct 30 are arranged in order from the door side toward the inside, in the space below the seat cushion 10a of the rear seat 10.

Next, the flow of air in the battery cooling structure of this example embodiment will be described. Air inside the vehicle cabin is drawn in from the inlet 62 by driving the blower 28. This air is drawn into the blower 28 via the intake air duct 60. Discharged air from the blower 28 is supplied into an upper space (i.e., a supply air flow path) in the battery pack 20 via the supply air duct 26. The battery stack 22 is arranged inside the battery pack 20, but because there is a gap between battery modules 24 of the battery stack 22; the air flows downward through this gap, such that the battery modules 24 are effectively cooled. Here, cooling air is able to be made to pass through this gap between the stacked battery modules 24 by closing off the area between the periphery of the battery stack 22 and a peripheral inside wall of the battery pack 20.

Exhaust air is discharged from a lower space (i.e., an exhaust air flow path) in the battery pack 20 into the luggage space 40 through the exhaust air duct 30, the exhaust port 32, the discharge duct 48, the discharge port panel 50, and the exhaust vent 54 that is the gap between the tip end of the deck board 42 and the back surface of the seatback 10b. In this example, the exhaust vent 54 is positioned along almost the entire width in the vehicle width direction, but it may also be limited to only a specific portion.

Next, the individual structures of the battery cooling structure of this example embodiment will be described. In FIGS. 1A and 1B, only one rear seat 10 is shown, but normally there are two rear seats 10, and the battery packs 20, as well as a mechanism for cooling the battery packs 20, are arranged with the same configuration under the rear seats 10, as shown in FIGS. 1A and 1B.

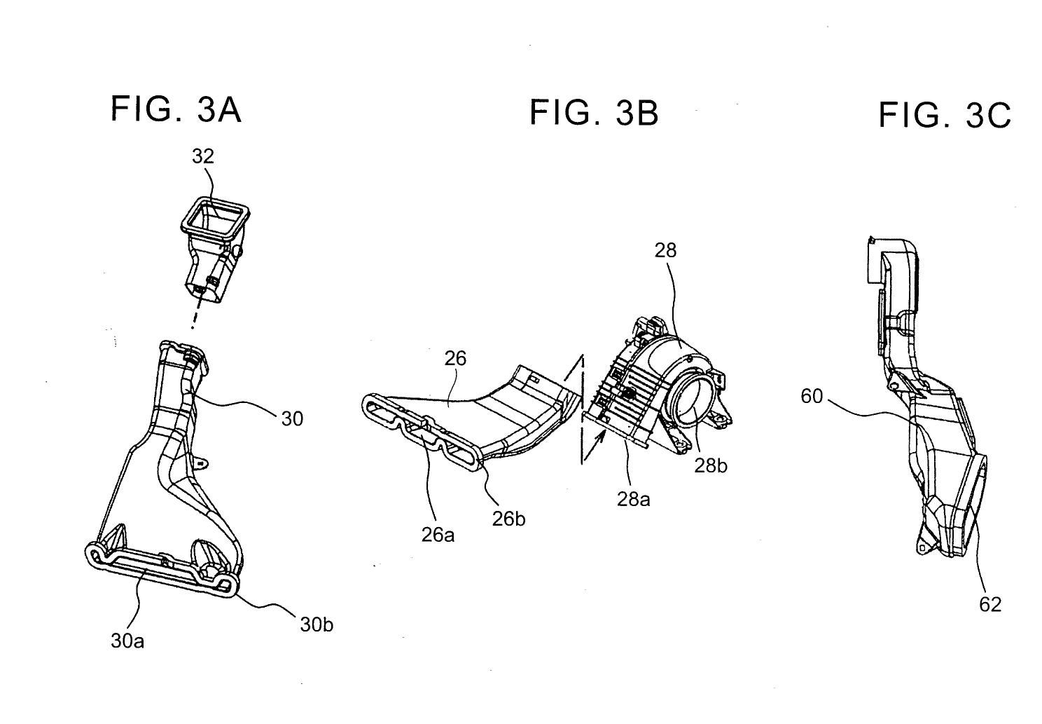

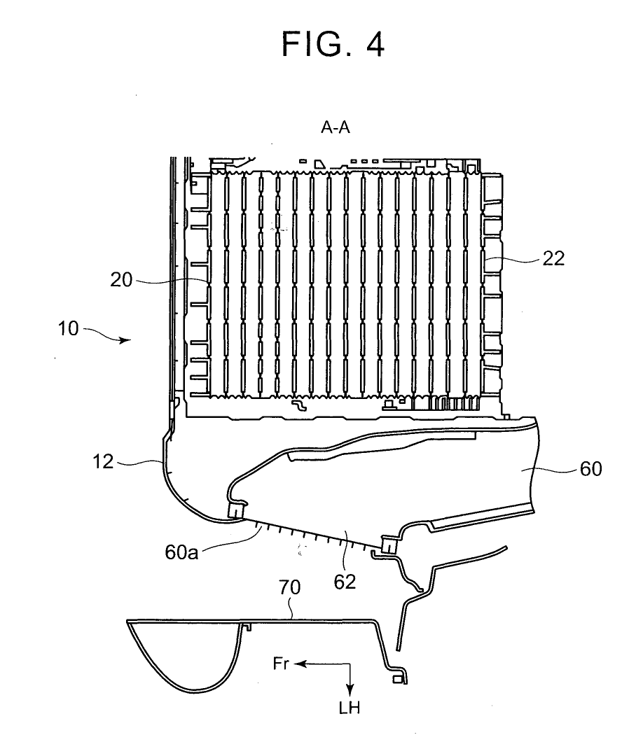

Here, FIGS. 3A, 4B, and 4C are views of the exteriors of the exhaust air duct 30, the supply air duct 26, and the intake air duct 60, respectively. As shown in FIG. 3A, the exhaust air duct 30 extends toward the rear from a rear end of a lower-case that forms a bottom surface of the battery pack 20. As shown in the drawings, a front end of the exhaust air duct 30 is a flat opening that is vertically narrow (i.e., narrow in the vehicle height direction) and wide (in the vehicle width direction). Air from the whole discharge flow path below the battery stack 22 is discharged from this opening. The width of the exhaust air duct 30 gradually narrows toward the exhaust port 32, and the exhaust port 32 is a generally square-shaped opening.

Also, a periphery of an open portion 30a of the front end of the exhaust air duct 30 is reinforced by a flange portion 30b. This open portion 30a is connected to the discharge flow path in an airtight manner by placing the lower side of the flange portion 30b close against the lower case and holding the upper side of the flange portion 30b down against the rear side end portion of the battery stack 22. A. side portion of the flange portion 30b is connected in an airtight manner to an inside wall of an upper cover that covers a side portion and an upper portion of the battery pack 20. An airtight seal is achieved by arranging a sealant around the flange portion 30b.

A more reliable seal is achieved by providing a recessed portion that is recessed downward in two locations as shown in FIG. 3A, on an upper edge portion of the flange portion 30b, and adjusting the shape of a lower surface of the rear end of the battery stack 22 accordingly. Also having the recessed portion directly contact the lower edge portion of the flange portion gives the flange portion 30b sufficient strength.

The front end of the supply air duct 26 is a flat open portion 26a that is vertically narrow and wide in the width direction, matching the shape of the upper space (Le., the supply air flow path) of the battery pack 20, as shown in FIG. 3B. Also, a flange portion 26b is formed around the open portion 26a, and the periphery of this flange portion 26b is sealed via a sealant between the rear upper end portion of the battery stack 22 and the upper cover of the battery pack 20. The supply air duct 26 extends toward the rear, while the width thereof gradually becomes narrower. This supply air duct 26 is connected to an air outlet 28a around the blower 28. The blower 28 has a cylindrical shape and blows air drawn in from a side intake port 28b, out in a radial direction from the air outlet 28a provided in a portion of a donut-shaped blowing chamber.

The intake air duct 60 has a pipe-shape that extends from the- front toward the rear, and the rear end of the intake air duct 60 is connected to the intake port 28b of the blower 28, as shown in FIG. 3C. The front end is a rectangular-shaped inlet 62.

Next, the structure related to intake air of the battery cooling structure of this example embodiment will be described. Here, the structures of the intake air duct 60 and the inlet 62 will be described with reference to FIGS. 4 to 6.

As shown in FIG. 2, the intake air duct 60 is connected to the intake side of the blower 28 by the intake air duct 60 that extends from the inlet 62 that is open on the side surface of the rear seat 10.

FIG. 4 is a sectional view taken along line A-A in FIG. 1A. In this way, the intake air duct 60 that is a space below the seat cushion 10a in the rear seat 10 is arranged on the door 70 side of the battery pack 20. This intake air duct 60 extends toward the rear from the side portion of the rear seat 10. The inlet 62 is provided on the lower trim 12 on the side surface on the door 70 side of the rear seat 10. Therefore, when the door 70 is closed, the inlet 62 opposes the inside surface of the door 70, and is thus not easily accessible by an occupant. Also, the likelihood of an object being placed in this space is low, so the likelihood of the inlet 62 becoming blocked is low.

Also, as shown in the drawings, the inlet 62 is shaped so as to be closer to the door side farther toward the rear of the vehicle, and thus can be seen from the front. As a result, air is more easily taken in regardless of the inlet 62 being provided opposite the door 70.

Also, a protective surface 60a such as lattice or cloth is placed over the front side of the inlet 62, which inhibits foreign objects and the like from getting in without greatly increasing air resistance.

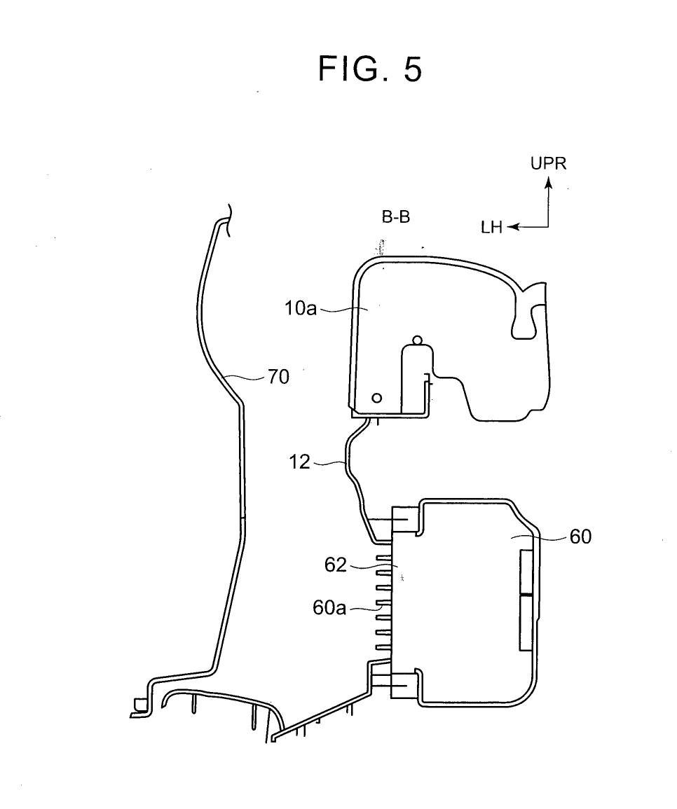

FIG. 5 is a sectional view taken along line B-B in FIG. 1A. In this way, the intake air duct 60 is positioned on the door side of the space below the seat cushion 10a of the rear seat 10, and the inlet 62 is positioned on the door-side side of the lower trim 12 of the rear seat 10.

Here, the lower trim 12 above the inlet 62 protrudes in the direction of the door 70 compared to the surface in the perpendicular direction of the inlet 62, and the inlet 62 is positioned recessed from the surface of the lower trim. As a result, the likelihood of the inlet 62 being blocked by an object falling from above is low.

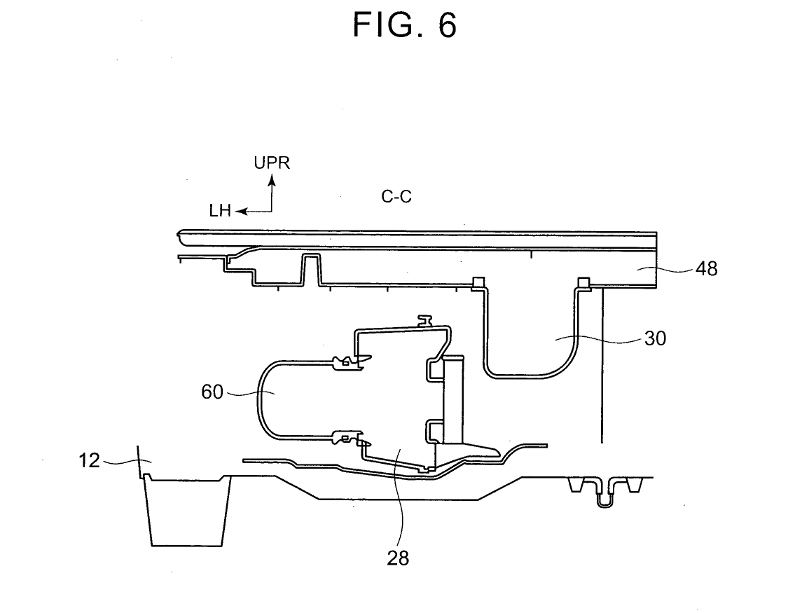

FIG. 6 is a sectional view taken along line C-C in FIG. 1A. In this way, the rear end of the intake air duct 60 is connected to the intake port of the blower 28. The blower 28 rotates an impeller, not shown, around a horizontal axis in the drawing, and pushes the air drawn in from the side out into the outside space. Then the air is delivered to the supply air duct 26 that is connected to the outside space of this blower 28, and this air is supplied to a space above the battery pack 20 via the supply air duct 26.

Next, the effects of the example embodiment will be described. With the battery cooling structure of this example embodiment, the inlet 62 of the blower for cooling the battery is provided on a side portion of the rear seat 10, i.e., on a portion of the lower trim 17 positiohed below the seat cushion 10a that is opposite the door 70.

Therefore, the inlet 62 is not easily accessible by an occupant, so the likelihood of a foreign object getting into the inlet 62 or the inlet 62 becoming blocked by an object or the like is low.

Also, the battery pack 20 and the intake air duct 60 are arranged inside the rear seat 10, so the effective utilization of space is able to be improved. Also, the blower 28 is positioned behind to the rear seat 10, so the effect on an occupant is small.

Moreover, exhaust air from the battery pack 20 is discharged into the luggage space, so the effect from exhaust air on an occupant is small.

1. A battery cooling structure for cooling a battery mounted in a vehicle, the battery cooling structure comprising:
a battery pack within which the battery is housed in an internal space of the battery pack;
a blower configured to deliver cooling air into the battery pack; and
an intake air duct that is connected to an intake side of the blower, the intake air duct having an inlet that is provided only on a side surface on a door side of a lower trim, and the lower trim being positioned on an outer edge of a space below a seat cushion of the vehicle.

2. The battery cooling structure according to claim 1, wherein
an intake side of the battery pack and the intake air duct is arranged in the space below the seat cushion of the vehicle.

3. A battery cooling structure for cooling a battery mounted in a vehicle, the battery cooling structure comprising:
a battery pack within which the battery is housed in an internal space of the battery pack;
a blower configured to deliver cooling air into the battery pack; and
an intake air duct that is connected to an intake side of the blower, an intake side of the battery pack and the intake air duct being arranged in a space below a seat cushion of the vehicle, an inlet of the intake air duct being provided in a side surface on a door side of a lower trim, and the lower trim being positioned on an outer edge of the space below the seat cushion.

4. The battery cooling structure according to claim 1, wherein
the inlet of the intake air duct is slanted with respect to a vehicle front-rear direction so as to come closer to the door side farther toward a rear of the vehicle.

5. The battery cooling structure according to claim 1, wherein the inlet of the intake air duct is arranged in a position farther away from the door than the door side outer edge of the seat cushion.

6. The battery cooling structure according to claim 1, wherein the inlet of the intake air duct is arranged in a position recessed from a surface of the lower trim, with respect to the door side outer edge of the seat cushion.

7. The battery cooling structure according to claim 1, wherein
the inlet of the intake air duct is arranged in a position farther away from the door than the door side outer edge of the seat cushion, and the inlet of the intake air duct is arranged in a position recessed from the surface of the lower trim with respect to the door side outer edge of the seat cushion.

8. The battery cooling structure according to claim 3, wherein
the inlet of the intake air duct is slanted with respect to a vehicle front-rear direction so as to come closer to the door side farther toward a rear of the vehicle.

9. The battery cooling structure according to claim 3, wherein the inlet of the intake air duct is arranged in a position farther away from the door than the door side outer edge of the seat cushion.

10. The battery cooling structure according to claim 3, wherein the inlet of the intake air duct is arranged in a position recessed from a surface of the lower trim, with respect to the door side outer edge of the seat cushion.

11. The battery cooling structure according to claim 3, wherein
the inlet of the intake air duct is arranged in a position farther away from the door than the door side outer edge of the seat cushion, and the inlet of the intake air duct is arranged in a position recessed from the surface of the lower trim with respect to the door side outer edge of the seat cushion.
